(19) United States
(12) Patent Application Publication
(10) Pub. No.: US 2013/0247210 A1
(43) Pub. Date: Sep. 19, 2013

(54) Method and System for Protecting Software Authorization

(71) Applicant: Chi-Chou Huang, New Taipei City (TW)

(72) Inventor: Chi-Chou Huang, New Taipei City (TW)

(21) Appl. No.: 13/485,949

(22) Filed: Jun. 1, 2012

(30) Foreign Application Priority Data
Mar. 13, 2012 (TW) 101108427

(51) Int. Cl. G06F 21/00

(52) U.S. Cl. 726/26

(57) ABSTRACT

A method for protecting a software authorization utilized in a software installed in a hardware device, which includes a timer to utilize a system time, and including a plurality of functions is disclosed. The method includes setting an authorized time, an accumulated authorization time, an accumulated running time and a last recorded time when the software is initially installed in the hardware device, operating a time-out check for determining whether the software authorization is expired or not according to the system time, the authorized time, the accumulated authorization time, the accumulated running time and the last recorded time when the software is initiated or the plurality of functions are initiated or terminated, and stopping the software from running in the hardware device when the software authorization is expired.

### BACKGROUND OF THE INVENTION

1. Field of the Invention

The present invention relates to a method and a system for protecting a software authorization, and more particularly, to a method and a system for protecting a software authorization which utilizes a plurality of parameters and a time-out check.

2. Description of the Prior Art

Along with advancing technologies, a variety of application software has been developed to be applied with different user requirements or systems. Meanwhile, accompanying the fast upgraded hardware or newly added functions of the variety of application software, users can anticipate more and more application software to be equipped with security keys sold in the market, so as to provide the users legally authorized utilization of the application software as well as protecting intelligent property rights. During a renewing process, most users follow the legal rules to obtain a new version of application software. However, some users try to access illegal application software via the Internet, such as from a forum to directly get the application software or the authorized security keys illegally, and some try to rewrite the internal system time of the hardware (e.g. the personal computer) to prevent an authorized period of the legal application software from being expired. Accordingly, a great negative impact has been brought to the hard-working application software designers.

Therefore, it has become an important issue to provide a method for efficiently protecting a software authorization, which prevents illegal users from easily getting the authorized security keys or from rewriting the internal system time of the hardware to longer the authorized period of the software, so as to enhance the protective mechanism of the software authorization.

### SUMMARY OF THE INVENTION

It is therefore an objective of the invention to provide a method and a system for protecting a software authorization, so as to prevent users from rewriting the internal system time of the hardware to enhance the protective mechanism of the software authorization.

An embodiment of the invention discloses a method for protecting a software authorization utilized in a software installed in a hardware device, which comprises a timer to generate a system time, and comprising a plurality of functions. The method comprises setting an authorized time, an accumulated authorization time, an accumulated running time and a last recorded time when the software is initially installed in the hardware device; operating a time-out check for determining whether the software authorization is expired or not according to the system time, the authorized time, the accumulated authorization time, the accumulated running time and the last recorded time when the software is initiated or the plurality of functions are initiated or terminated; and stopping the software from running in the hardware device when the software authorization is expired.

An embodiment of the invention also discloses another computer system comprising a central processing unit; a timer for generating a system time; a storage device for storing a software and a programming code, wherein the programming code is utilized to instruct the central processing unit to correspondingly operate a method for protecting a software authorization and the software comprises a plurality of functions. The method comprises setting an authorized time, an accumulated authorization time, an accumulated running time and a last recorded time when the software is initially installed in the hardware device; operating a time-out check for determining whether the software authorization is expired or not according to the system time, the authorized time, the accumulated authorization time, the accumulated running time and the last recorded time when the software is initiated or the plurality of functions are initiated or terminated; and stopping the software from running in the hardware device when the software authorization is expired.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a computer system for protecting a software authorization according to an embodiment of the invention.

FIG. 2 illustrates a flow chart of a software authorization process according to an embodiment of the invention.

FIG. 3 illustrates a flow chart of a time-out check process according to an embodiment of the invention.

### DETAILED DESCRIPTION

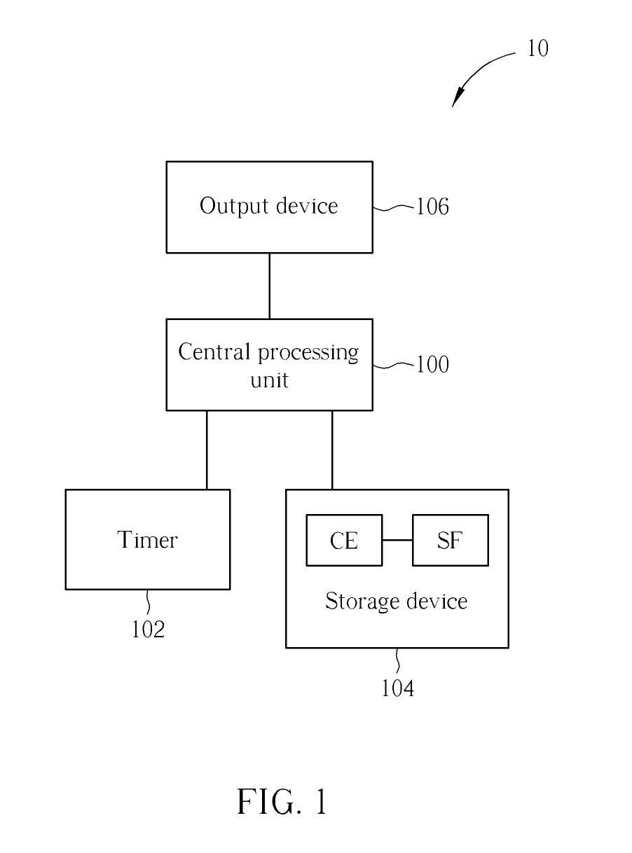

Please refer to FIG. 1, which illustrates a schematic diagram of a computer system 10 for protecting a software authorization according to an embodiment of the invention. As shown in FIG. 1, the computer system 10 includes a central processing unit 100, a timer 102, a storage device 104 and an output device 106. The timer 102 is utilized for generating a system time to correspondingly input into the central processing unit 100, and the system time synchronizes with the Greenwich Mean Time (GMT) according to different time zones where the computer system 10 is located. The storage device 104 stores at least a software SF and a programming code CE according to different user requirements. The programming code CE is utilized to instruct the central processing unit 100 for different operations. The programming code CE includes a software authorization process for protecting the software SF, and a time-out check is operated during the operation of the software authorization process. After obtaining permission from the time-out check process, a plurality of functions (not shown in the figure) of the software SF has the permission to operate. Last, the output module 106 outputs computational results of the central processing unit 100, so as to finish the operations of the computer system 10 instructed by the user. For example, the software SF is the Microsoft Office Excel 2010 Version, and one of the functions is an operation to depict a table. According to an effective authorized period of the Microsoft Office Excel 2010 Version, such as 20 years, the user will be unable to operate the Microsoft Office Excel 2010 Version on a personal computer after executing the software for 20 years.

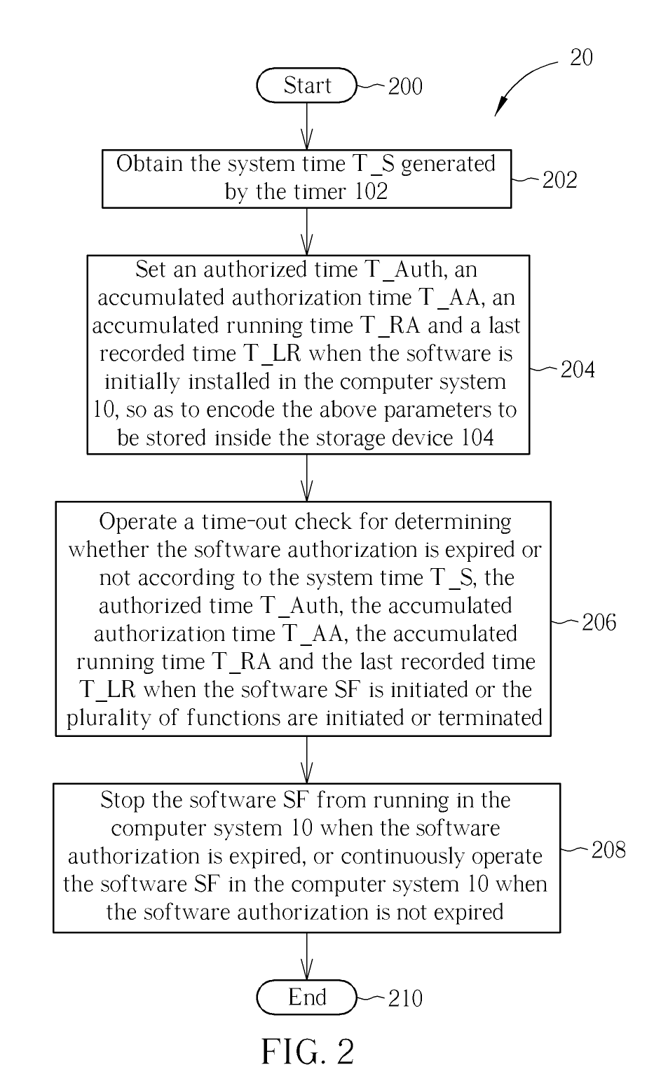

Please refer to FIG. 2, which illustrates a flow chart of a software authorization process 20 for protecting the software SF according to an embodiment of the invention. The software authorization process 20 can be complied into the programming code CE, which instructs the central processing unit 100 to protect the software SF via the software authorization process 20. Preferably, the complied programming code CE of the software authorization process 20 can be pre-stored inside the storage device 104 or accompanying the software SF as another programming code, so as to be installed accompanying the software SF in the storage device 104, which is also the scope of the invention. The software authorization process 20 includes the steps as follows:

Step 200: Start.

Step 202: Obtain the system time TS generated by the timer 102.

Step 204: Set an authorized time T_Auth, an accumulated authorization time T_AA, an accumulated running time T_RA and a last recorded time T_LR when the software is initially installed in the computer system 10, so as to encode the above parameters to be stored inside the storage device 104.

Step 206: Operate a time-out check for determining whether the software authorization is expired or not according to the system time T_S, the authorized time T_Auth, the accumulated authorization time

T_AA, the accumulated running time T RA and the last recorded time T_LR when the software SF is initiated or the plurality of functions are initiated or terminated.

Step 208: Stop the software SF from running in the computer system 10 when the software authorization is expired, or continuously operate the software SF in the computer system 10 when the software authorization is not expired.

Step 210: End.

The detailed steps of the software authorization process 20 are shown as follows. In step 202, when the computer system 10 first initiates, the timer 102 outputs the system time T_S into the central processing unit 100 to be the reference time for the following operation. In step 204, when the user first installs the software SF, the computer system 10 is driven to set a plurality of parameters, such as the authorized time T_Auth, the accumulated authorization time T_AA, the accumulated running time T_RA and the last recorded time T_LR as a test file or a digital format to be correspondingly encoded and stored in the storage device 104. Preferably, the authorized time T_Auth is predetermined by the software designer when the software SF is purchased by the user. For example, an effective authorized period of the software SF is 3 months, and the software SF is initially installed in the computer system 10 on 2012/01/15. Next, the software authorization process 20 transforms the authorized time T_Auth (i.e. 3 months) into the accumulated authorization time T_AA. In this embodiment, 3 months is transformed into the format of hours as 3*30*24=2160 hours, and 2160 hours is set to be the accumulated authorization time T_AA. Additionally, the last recorded time T_LR is set to be the system time T_S, and the accumulated running time T_RA is set initially to be zero. During the operations of the software SF as well as the plurality of functions, the operated periods of the software SF are then added to the accumulated running time T_RA, and simultaneously, the system time T_S is set equal to the last recorded time T_LR after the software SF is terminated. All the parameters are the reference for the following steps.

In step 206, whenever the software SF is initiated without running any of the plurality of functions, or the software SF is initiated with running at least one of the plurality of functions, or at least one of the plurality of functions is terminated, the system time T_S, the authorized time T_Auth, the accumulated authorization time T_AA, the accumulated running time T_RA and the last recorded time T_LR are inputted into the time-out check for determining whether the software authorization is expired or not. Last, in step 208, according to the determination result of the time-out check, the software SF is determined to be stopped or continuously run in the computer system 10. Thus, when the software authorization process 20 determines the software SF is to be stopped in the computer system 10, the user is not able to operate the software SF. On the contrary, when the software authorization process 20 determines the software SF is to be continuously run in the computer system 10, the software authorization process 20 will return to step 202 to repeat the cycle from step 202 to step 210, so as to timely monitor whether the software authorization of the software SF is expired or not.

Simply, the software authorization process 20 monitors the software authorization of the software SF at any moment and sets the plurality of parameters to operate the time-out check. In this embodiment, the software authorization process 20 utilizes the parameters such as the system time T_S, the authorized time T_Auth, the accumulated authorization time T_AA, the accumulated running time T_RA and the last recorded time T_LR. During the operation or completion of the software SF or the plurality of functions, those skilled in the art can correspondingly predetermine other parameters according to the concept of the embodiment, so as to process other similar check operations, which is also within the scope of the invention.

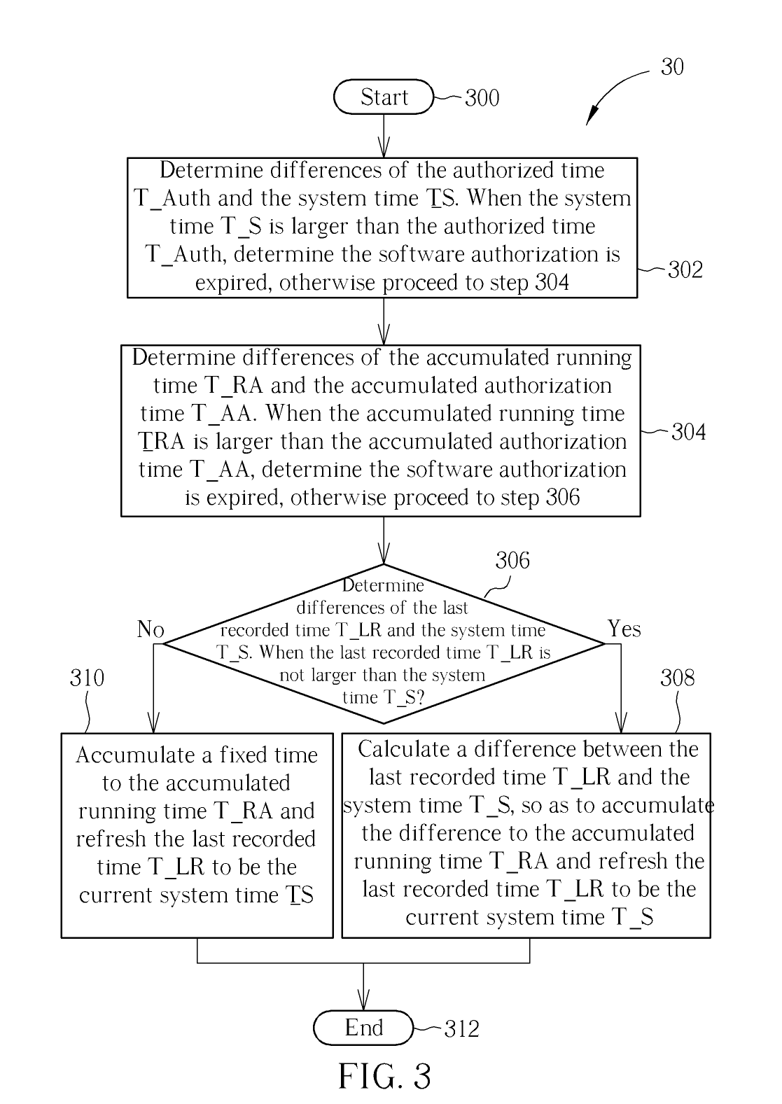

Furthermore, as mentioned in step 206, the detailed description that whenever the software SF is initiated, or the software SF is initiated with running at least one of the plurality of functions, or at least the one of the plurality of functions is terminated, the system time T_S, the authorized time T_Auth, the accumulated authorization time T_AA, the accumulated running time T_RA and the last recorded time T_LR are inputted into the time-out check for determining whether the software authorization is expired or not can be summarized as a time-out check process 30, as shown in FIG. 3, and the time-out check process 30 can be compiled into another programming code CE accompanying the programming code CE of the software authorization process 20. The time-out check process 30 includes the steps as follows:

Step 300: Start.

Step 302: Determine differences of the authorized time T_Auth and the system time T_S. When the system time T_S is larger than the authorized time T_Auth, determine the software authorization is expired, otherwise proceed to step 304.

Step 304: Determine differences of the accumulated running time T_RA and the accumulated authorization time T_AA. When the accumulated running time T_RA is larger than the accumulated authorization time T_AA, determine the software authorization is expired, otherwise proceed to step 306.

Step 306: Determine differences of the last recorded time T_LR and the system time T_S. When the last recorded time T_LR is not larger than the system time T_S, proceed to step 308, otherwise proceed to step 310.

Step 308: Calculate a difference between the last recorded time T_LR and the system time T_S, so as to accumulate the difference to the accumulated running time T_RA and refresh the last recorded time T_LR to be the current system time T_S.

Step 310: Accumulate a fixed time to the accumulated running time T_RA and refresh the last recorded time T_LR to be the current system time T_S.

Step 312: End.

In detail, the time-out check process 30 determines whether the software authorization for protecting the software SF is expired or not according to the differences between the authorized time T_Auth and the system time T_S, the differences between accumulated running time T_RA and the accumulated authorization time T_AA or the differences between the last recorded time T_LR and the system time T_S.

Step 302 compares the differences between the authorized time T_Auth and the system time T_S. For example, the predetermined authorized time T_Auth is expired on 2012/04/15, and the system time T_S is 2012/04/16. The time-out check process 30 via the operation of the central processing unit 100 determines that the system time T_S is larger than the authorized time T_Auth, and correspondingly determines the software authorization is expired, so as to stop the software SF from operating in the computer system 10. If the system time T_S is not larger than the authorized time T_Auth, proceed to step 304.

Step 304 compares the differences between the accumulated running time T_RA and the accumulated authorization time T_AA. For example, the accumulated authorization time T_AA is predetermined to be 400 hours from 2012/01/15 to 2012/04/14, the software SF has just operated for 2 months where 30 days is counted as a month, and the format of the accumulated running time T_RA is set equal to 8 hours a day for operating the software SF. Thus, the accumulated running time T_RA is 2*30*8=480 hours. Further, the time-out check process 30 via the operation of the central processing unit 100 determines that the accumulated running time T_RA is larger than the accumulated authorization time T_AA, and correspondingly determines the software authorization is expired, so as to stop the software SF operating in the computer system 10. If the accumulated running time T_RA is not larger than the accumulated authorization time T_AA, proceed to step 306.

Step 306 compares the differences between the last recorded time T LR and the system time T_S. When the last recorded time T_LR is not larger than the system time T_S, the time-out check process 30 via the operation of the central processing unit 100 determines to enter into step 308. Step 308 calculates the difference between the last recorded time T_LR and the system time T_S, and accumulates the difference to the accumulated running time T_RA. For example, the current system time T_S is at twelve o'clock on 2012/04/14 and the last recorded time T_LR is at eight o'clock on 2012/04/14, which results in the difference to be 4 hours. Next, the accumulated running time T_RA is accumulated by 4 hours to be equal to 484 hours, and the central processing unit 100 also refreshes the last recorded time T_LR to be the current system time T_S.

Additionally, in step 306, if the last recorded time T_LR is larger than the system time T_S, it can be obvious that the user manipulated the system time T_S of the computer system 10, so as to lengthen the authorized period of the software SF via going back to an older system time. Under such circumstances, in order to prevent the user from manipulating the system time T_S, the time-out check process 30 enters into step 310 to accumulate the fixed time to the last recorded time T_LR and to reset the last recorded time T_LR to be the current system time T_S. The software authorization is temporarily determined not to be expired. Preferably, the fixed time has different predetermined values corresponding to different operations of the software SF. For example, when the software SF or the plurality of functions is/are initiated, 3 days is accumulated to the accumulated running time T_RA. When the plurality of functions is terminated, 1 minute is accumulated to the accumulated running time T_RA. Certainly, the fixed time hereinafter is demonstrated as an example, and those skilled in the art can adaptively modify the fixed time, so as to avoid the user manipulating the system time T_S and the operational errors of the accumulated running time T_RA or the last recorded time T_LR. Although step 310 temporarily determines the software authorization is not expired with the situation that the user has manipulated the system time T_S switching from being expired to being not expired, step 310 will eventually return back to the software authorization process 20 to operate the time-out check process 30 again. Accordingly, the software authorization will be determined to be expired to stop the user from continuously operating the software SF, so as to prevent the situation that the user arbitrarily manipulates the system time T_S to lengthen the authorized period of the software SF.

Noticeably, those skilled in the art can adaptively change/modify the order of the step 302 to step 310 of the time-out check process 30, or change/modify the order the time-out check process 30 accompanying the software authorization process 20, which is not limiting the scope of the invention. Besides, driving conditions of the software authorization process 20 or the time-out check process 30 can be adaptively changed/modified to avoid whenever the software SF is initiated, or the plurality of functions are initiated or terminated. Based upon the computational complexity of the software SF as well as the plurality of functions, the software authorization process 20 or the time-out check process 30 can be adaptively operated with a few randomly selected from the above driving conditions whenever the software SF is initiated, or the plurality of functions are initiated or terminated, so as to provide an effective mechanism for determining whether the software authorization is expired or not, which is also within the scope of the invention.

Moreover, during the operation of the software authorization process 20 or the time-out check process 30, the parameters of the authorized time T_Auth, the accumulated authorization time T_AA, the accumulated running time T_RA and the last recorded time T_LR are continuously refreshed and stored in the storage device 104. Under such circumstances, the embodiment of the invention can further combine an encoding program or store the above parameters within a storage zone which cannot be accessed by the user, so as to prevent the user from directly manipulating the above parameters and enhance the protective mechanism of the software authorization process 20 or the time-out check process 30.

In summary, the invention provides a method and a system for protecting a software authorization of a software including a plurality of functions. When the software is initially installed in a hardware device, a plurality of parameters are predetermined, such as an authorized time, an accumulated authorization time, an accumulated running time and a last recorded time. Also, a system time of the hardware device is also taken into consideration. Before the software is initiated or at least one of a plurality of functions is initiated, or after the one of the plurality of functions is terminated, a time-out check is operated to prevent the software authorization from being expired, which also prevents any users from arbitrarily obtaining a security key for the software or from manipulating the system time in order to lengthen an authorized period of the software. Furthermore, a combination with an encoding program is added to prevent the above parameters from being arbitrarily accessed by the user to enhance the protective mechanism of the software authorization.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for protecting a software authorization utilized in a software installed in a hardware device, which comprises a timer to generate a system time, and comprising a plurality of functions, the method comprising:
setting an authorized time, an accumulated authorization time, an accumulated running time and a last recorded time when the software is initially installed in the hardware device;
operating a time-out check for determining whether the software authorization is expired or not according to the system time, the authorized time, the accumulated authorization time, the accumulated running time and the last recorded time when the software is initiated or the plurality of functions are initiated or terminated; and
stopping the software from running in the hardware device when the software authorization is expired.

2. The method of claim 1, wherein the time-out check further comprises:
determining differences of the authorized time and the system time, or determining differences of the accumulated running time and the accumulated authorization time, or determining differences of the last recorded time and the system time, so as to determine whether the software authorization is expired or not.

3. The method of claim 2, wherein the step of determining the differences of the authorized time and the system time, or determining the differences of the accumulated running time and the accumulated authorization time, or determining the differences of the last recorded time and the system time, so as to determine whether the software authorization is expired or not, further comprises:
determining the software authorization is expired when the system time is larger than the authorized time.

4. The method of claim 2, wherein the step of determining the differences of the authorized time and the system time, or determining the differences of the accumulated running time and the accumulated authorization time, or determining the differences of the last recorded time and the system time, so as to determine whether the software authorization is expired or not, further comprises:
determining the software authorization is expired when the accumulated running time is larger than the accumulated authorization time.

5. The method of claim 2, wherein the step of determining the differences of the authorized time and the system time, or determining the differences of the accumulated running time and the accumulated authorization time, or determining the differences of the last recorded time and the system time, so as to determine whether the software authorization is expired or not, further comprises:
refreshing the accumulated running time according to the differences of the last recorded time and the system time when the last recorded time is not larger than the system time; and
setting the last recorded time to be the current system time and determining the software authorization is not expired.

6. The method of claim 5, wherein the step of refreshing the accumulated running time according to the differences of the last recorded time and the system time when the last recorded time is not larger than the system time, further comprises:
accumulating the difference of the last recorded time and the system time to the accumulated running time when the last recorded time is not larger than the system time.

7. The method of claim 2, wherein the step of determining the differences of the authorized time and the system time, or determining the differences of the accumulated running time and the accumulated authorization time, or determining the differences of the last recorded time and the system time, so as to determine whether the software authorization is expired or not, further comprises:
refreshing the accumulated running time according to a fixed time when the last recorded time is larger than the system time; and
setting the last recorded time to be the current system time and determining the software authorization is not expired.

8. The method of claim 7, wherein the step of refreshing the accumulated running time according to the fixed time when the last recorded time is larger than the system time, further comprises:
accumulating the fixed time to the accumulated running time.

9. The method of claim 8, wherein the fixed time is set equal to 3 days when the software is initiated or the plurality of functions are initiated, and the fixed time is set equal to 1 minute when the plurality of functions are terminated.

10. The method of claim 8, wherein a format of the accumulated running time is set as a day comprises 8 hours.

11. The method of claim 1, wherein the accumulated authorization time is generated by transforming the authorized time, and a format of the accumulated authorization time is set as a day comprises 24 hours.

12. The method of claim 1, wherein the authorized time, the accumulated authorization time, the accumulated running time and the last recorded time are stored in a digital format.

13. The method of claim 12, wherein the digital format is encoded to store in a storage device of the hardware device.

14. The method of claim 1, wherein the software continuously runs in the hardware device when the software authorization is not expired.

15. A computer system comprising:
a central processing unit;
a timer for generating a system time;
a storage device for storing a software and a programming code, wherein the programming code is utilized to instruct the central processing unit to correspondingly operate a method for protecting a software authorization and the software comprises a plurality of functions, the method comprising:
setting an authorized time, an accumulated authorization time, an accumulated running time and a last recorded time when the software is initially installed in the hardware device;
operating a time-out check for determining whether the software authorization is expired or not according to the system time, the authorized time, the accumulated authorization time, the accumulated running time and the last recorded time when the software is initiated or the plurality of functions are initiated or terminated; and
stopping the software from running in the hardware device when the software authorization is expired.

16. The computer system of claim 15, wherein the time-out check further comprises:
determining differences of the authorized time and the system time, or determining differences of the accumulated running time and the accumulated authorization time, or determining differences of the last recorded time and the system time, so as to determine whether the software authorization is expired or not.

17. The computer system of claim 16, wherein the step of determining the differences of the authorized time and the system time, or determining the differences of the accumulated running time and the accumulated authorization time, or determining the differences of the last recorded time and the system time, so as to determine whether the software authorization is expired or not, further comprises:
determining the software authorization is expired when the system time is larger than the authorized time.

18. The computer system of claim 16, wherein the step of determining the differences of the authorized time and the system time, or determining the differences of the accumulated running time and the accumulated authorization time, or determining the differences of the last recorded time and the system time, so as to determine whether the software authorization is expired or not, further comprises:
determining the software authorization is expired when the accumulated running time is larger than the accumulated authorization time.

19. The computer system of claim 16, wherein the step of determining the differences of the authorized time and the system time, or determining the differences of the accumulated running time and the accumulated authorization time, or determining the differences of the last recorded time and the system time, so as to determine whether the software authorization is expired or not, further comprises:
refreshing the accumulated running time according to the differences of the last recorded time and the system time when the last recorded time is not larger than the system time; and
setting the last recorded time to be the current system time and determining the software authorization is not expired.

20. The computer system of claim 19, wherein the step of refreshing the accumulated running time according to the differences of the last recorded time and the system time when the last recorded time is not larger than the system time, further comprises:
accumulating the difference of the last recorded time and the system time to the accumulated running time when the last recorded time is not larger than the system time.

21. The computer system of claim 16, wherein the step of determining the differences of the authorized time and the system time, or determining the differences of the accumulated running time and the accumulated authorization time, or determining the differences of the last recorded time and the system time, so as to determine whether the software authorization is expired or not, further comprises:
refreshing the accumulated running time according to a fixed time when the last recorded time is larger than the system time; and
setting the last recorded time to be the current system time and determining the software authorization is not expired.

22. The computer system of claim 21, wherein the step of refreshing the accumulated running time according to the fixed time when the last recorded time is larger than the system time, further comprises:
accumulating the fixed time to the accumulated running time.

23. The computer system of claim 22, wherein the fixed time is set equal to 3 days when the software is initiated or the plurality of functions are initiated, and the fixed time is set equal to 1 minute when the plurality of functions are terminated.

24. The computer system of claim 15, wherein a format of the accumulated running time is set as a day comprises 8 hours.

25. The computer system of claim 15, wherein the accumulated authorization time is generated by transforming the authorized time, and a format of the accumulated authorization time is set as a day comprises 24 hours.

26. The computer system of claim 15, wherein the authorized time, the accumulated authorization time, the accumulated running time and the last recorded time are stored in a digital format.

27. The computer system of claim 26, wherein the digital format is coded to store in the storage device.

28. The computer system of claim 15, wherein the software continuously runs in the hardware device when the software authorization is not expired.
